(19) United States
(12) Patent Application Publication
(10) Pub. No.: US 2006/0039137 A1
(43) Pub. Date: Feb. 23, 2006

(54) System for the commercialization of electronic candle illumination and electronic candle therefor

(76) Inventor: Gabor Lederer, Paterson, NJ (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/254,428

(22) Filed: Oct. 20, 2005

Related U.S. Application Data
(63) Continuation-in-part of application No. 10/666,731, filed on Sep. 19, 2003.
(60) Provisional application No. 60/453,611, filed on Mar. 11, 2003.

(51) Int. Cl. F21V 35/00

(52) U.S. Cl. 362/161

(57) ABSTRACT

A system provides for the commercialization of electronic candles in religious institutions or memorial locations wherein a prescribed payment for a predetermined illumination period is verified or validated and an electronic signal then actuates at least one of the electronic candles. The user selects the desired candle for illumination and touches the selected candle for illumination for the prescribed period. A payment account statement is periodically transmitted to the religious institution or manufacturer to confirm actual payments with the electronic statement of payments to control pilferage.

### PRIOR RELATED APPLICATIONS

This application is a continuation-in-part of U.S. Ser. No. 10/666,731, filed Sep. 19, 2003, which claims priority to provisional application Ser. No. 60/453,611, filed Mar. 11, 2003, which applications are incorporated herein in their entireties by reference thereto.

### BACKGROUND OF THE INVENTION

1. Field of Use

This invention relates to electronic candles. This invention also specifically relates to a system and method for the commercialization of electronic candle illuminations. This invention also relates to the commercialization of electronic candles wherein payments are made for lighting the candles for a certain period of time.

2. Discussion of the Background and Prior Art

Traditionally, wax candles, such as votive candles and tapers, have been used for memorialization and devotional purposes. Religious institutions generally provide for the purchase and lighting of the wax candles. Purchasers of the candles would make a donation of a desired or recommended amount, which amount is usually deposited in a collection box in order to acquire and light the wax candle.

Wax candles produce pollutants and soot, are a fire hazard. Insurance is costly where wax candles are in general use. The candle art turned to electronic candles, in which the user would touch or turn-on a candle that would then illuminate. Examples of electronic candles are disclosed in U.S. Pat. No. 6,066,924, U.S. Pat. No. 6,017,139, U.S. Pat. No. 5,863,108, U.S. Pat. No. 4,617,614 and U.S. Publication Application 2004/0179355 to Gabor Lederer, the inventor of the present invention. U.S. Patent Publication No. 2002/001373 to Shin et al. discloses an e-commerce method for authorizing the lighting of and paying for a wax candle at a remote location. The wax candle is lit and extinguished by one other then the user-purchaser. The user-purchaser is then expected to visit the burning candle at the remote location. This prior art method was abstruse and designed expressly for remote and candle illumination

The art directed to user-purchaser illumination provides the improvement of placing a motion sensor in the collection box. The motion sensor senses any object deposited into the collection box. A user by merely inserting a coin, bill, or piece of paper or any object by the user in the collection box effect actuation of an electronic candle for illumination. This prior art arrangement is shown in FIG. 1. This prior art method did not adequately control the payment for the illumination, and was unsatisfactory as a practical business means to both the religious institution and the electronic candle manufacturer. The art desired a method for the realistic commercialization of the illumination of electronic candles.

It is therefore a principal object of the present invention to provide a system and method for the commercialization of illuminations of electronic candles.

It is another object of the present invention to provide an improved electronic candle for the aforesaid commercialization.

It is another object of the present invention to provide a system and method as aforesaid, wherein the electronic candles are provided and maintained at religious institutions.

It is another principal object of the present invention to provide automated collection and pilfer control for the aforesaid commercialization of electronic candles, particularly for religious institutions.

It is yet another object of the present invention to provide an improved electronic candle and system which is of practical design, readily installed and operated and yet safe and practical in use.

The aforesaid objects are achieved by the present invention.

### SUMMARY OF THE INVENTION

This invention in one principal aspect is a system for the commercialization of electronic candle illuminations wherein payment is validated to actuate at least one candle of a plurality of candles. Once the candle is actuated for illumination, the user touches one candle to effect illumination for the prescribed time period. A chart or other visual means informs the user of the cost and committed illumination time period in order for the user to make an informed decision regarding payment. A currency validator or credit card payment validator senses the payment amount sends an electronic signal to a control unit or central unit wherein the illumination time is calculated, and in turn, an electronic signal is transmitted to the candles to actuate the candles for the prescribed time corresponding to the payment. The user touches a desired selected candle which is, by such touching, illuminated for the prescribed period. With illumination of the one selected candle, the remaining unlit candles are de-actuated. The system is made for each present or subsequent user—purchaser to make accurate payment and effect illumination of the related electronic candle.

The system induces encrypted or means for automatically providing encoded account statement of the candles illumination times and the corresponding payments represent those illuminations. The manufacturer of the electronic candles decrypts the account statement for confirming royalty or lease payments.

A stand is provided for mounting the candles in an arrangement. This arrangement provides the user with a diverse selection of positions from which to select the candle for illumination. The candles may also contain different indicia. This permits the user to select a candle that is most consistent with their devotional, memorial or emotional needs and desires.

### BRIEF DESCRIPTION OF THE DRAWINGS

FIG. 1 is a block diagram showing the prior art method of electronic candle illumination at a religious institution.

FIG. 2 is a block diagram of the overall commercialization system of the present invention; and

FIG. 3 is a detailed block diagram of the candle illumination system of the present invention.

### DESCRIPTION OF THE INVENTION

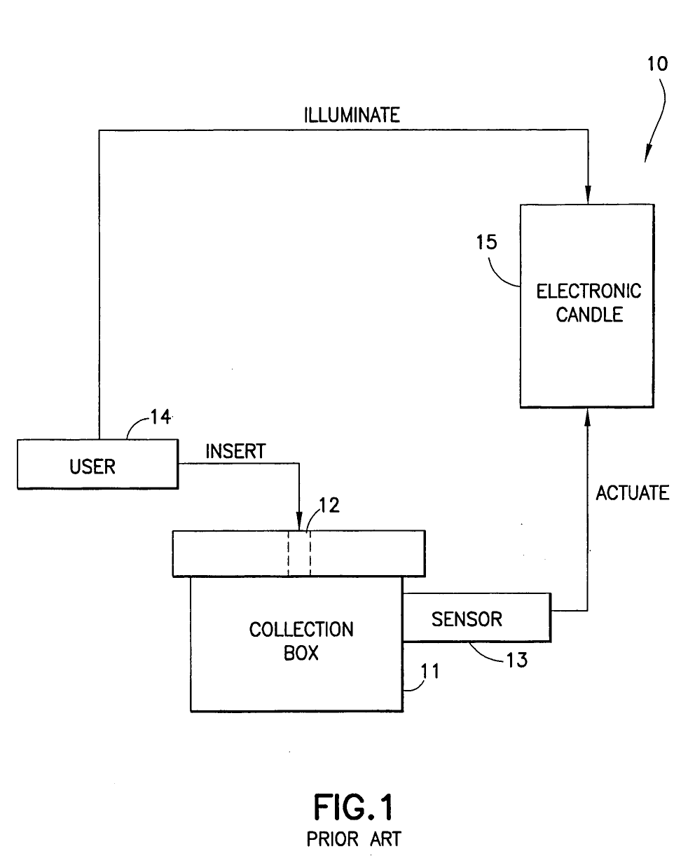

Referring to FIG. 1, there is shown a prior art electronic candle illumination system 10. System 10 is based on a collection box 11 having slot 12 of conventional construction. An object motion sensor 13 is mounted in the side of collection box 11. The user 14 inserts any object, e.g., coins, paper currency, token, paper, medals and the like, into slot 12. The sensor senses the object and in turn actuates at least one electronic candle 15 for illumination. The user then turns on the electronic candle 15 of their selection. This system did not provide a commercially viable system for candle illuminations, particularly for religious institutions and memorialization forums, e.g. cemeteries and memorials.

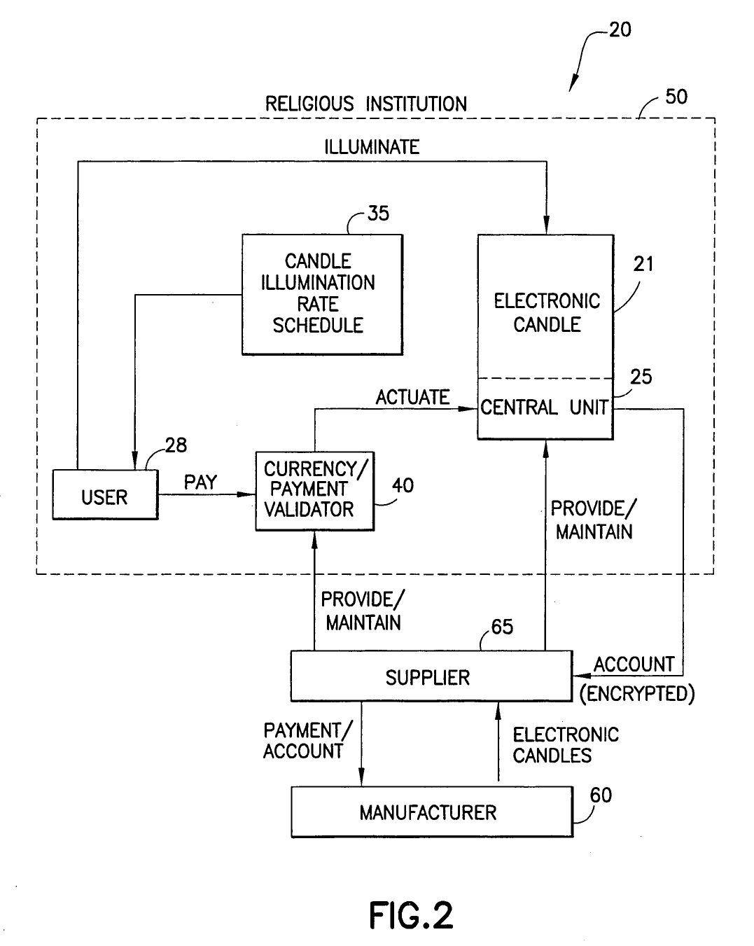

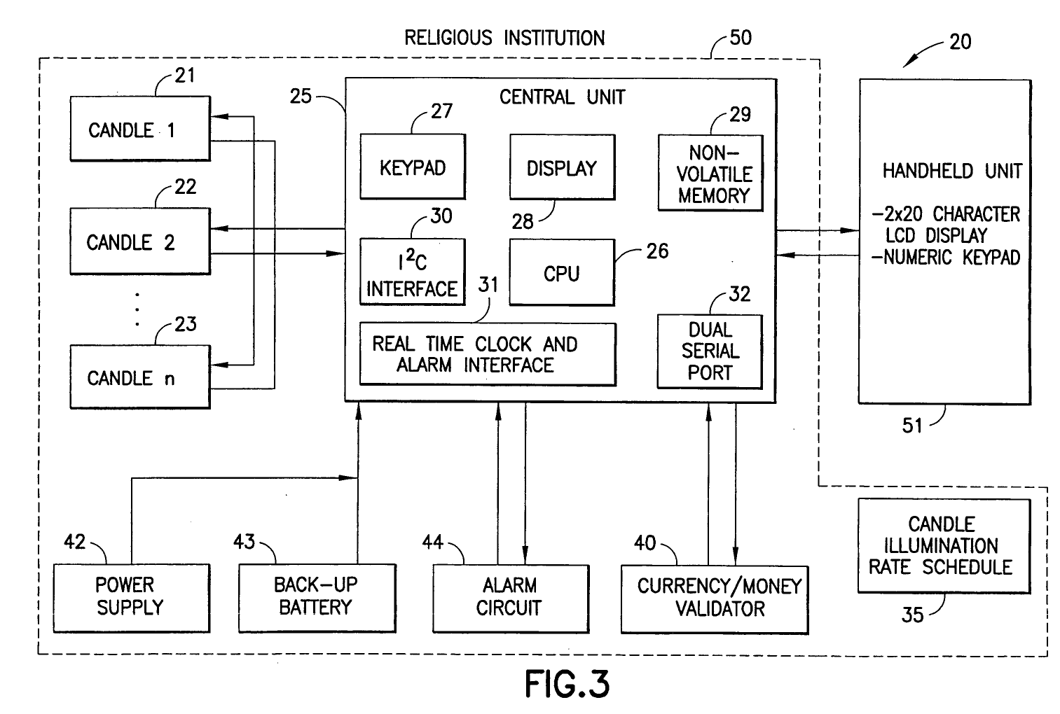

Referring to FIGS. 2 and 3, there is shown the system for the commercialization of electronic candies 20 of the present invention. System 20 includes a plurality of electronic candles, e.g. 21, 22 and 23. Electronic candles 21-23 imitate traditional wax candles, such as a votive or memorial candle, as will be further described hereinafter. A central unit or control unit 25 is another principal component of the system. Central unit 25 includes a CPU 26, keypad 27, display 28, non-volatile memory 29, I²C interface 30, real-time clock and alarm interface 31 and a dual serial port 32. The components 26-32 are assembled and programmed by means well know to one skilled in the control system art. While the invention is described as having an 12 Centrifuge, it is within the broad contemplation of the invention to utilize other commercialization references known in the electronic art.

A currency/payment validator 40 is a further principal component of the present invention. Currency/payment validator 40 may be of conventional design and construction wherein a bill in any one of several denominations is inserted in a slot (not shown) in currency/payment validator 40. The inserted bill is acknowledged by an alpha-numeric display or illumination element (not shown). The inserted bill sends an electronic signal to central unit 25. A candle illumination rate schedule 35 advises the user 28 as to the illumination time for a prescribed payment. The electronic signal from currency/payment validator 40 to central unit 25 informs the central unit of the candle illumination period for which the prescribed payment was made. Central unit 25 in turn actuates candles 21-23 for that prescribed illumination period. The user 28 then touches a selected candle, e.g. 21 and in so doing, illuminates the selected electronic candle for the prescribed time period.

A power supply 42, back-up battery power source 43 and alarm circuit 44 complete the assembly provided to and maintained at religious institutions 50. A hand held unit 51 may be plugged into central unit 25 for the purpose of recording the illumination times and/or payments mode. This account function may be encrypted in or encoded by central unit 25. A manufacturer 50 may retain decryption means to read the encrypted account information. The encrypted account information may be stored on a hand held device provided by manufacturer 50. A supplier 65 is under contract with the manufacturer to provide and manufacture the electronic candle 21-23, central unit 25 and currency/payment validator 40, as well as to take periodic account ready by means of hand held device 51, permit to a contractual arrangement with the manufacturer 50 and the religious institutions.

The present system 20 is provided on the aforesaid manner, which operation is desired is further discussed hereinafter.

One preferred electronic candle useful in the present invention is that shown and described in U.S. Pat. No. 6,017,139 granted Jan. 25, 2000 to Gabor Lederer, the invention herein, which disclosure is incorporated in its entirety herein by reference thereto. This electronic candle includes a spring loaded switch and timer element, wherein the user merely touches or presses down on the candle housing to effect illumination for the prescribed time period. In the present invention, the electronic candle is only first actuated after the currency/payment validator 40 validates the actual and correct currency payment or donation. Touching or otherwise manipulating the selected illuminated electronic candle will not interfere with the continue illumination for the payment prescribed period of time.

The Central Unit Operation

When currency/payment validator 40 senses a non-counterfeit bill and determines its face value, an electronic signal commensurate with the face value of the bill is sent to the central unit 25. The central unit calculates the prescribed illumination time for the currency value of that bill. The central unit then enters an electronic “ready to turn on” signal to every candle 21-23. The user then selects and turns on the selected electronic candle by pressing the top of the candle housing. This illumination of the candle will also send a recognition signal to the central unit 25. The recognition signal identifies the illuminated candle and the first of the illumination, as well as the illumination time. This information is stored in the central unit memory. The central unit then sends a “not ready” or “disabled” signal to the other candles. None of the other candles can be turned on until a new “ready to turn on” signal is generated. The central unit 25 tracks the illumination history of every candle. After the prescribed illumination time has elapsed, the central unit 25 sends a “turn off” signal to the afore-discussed illuminated candle. In order to insure user recovery in the event of power failure, every illumination start time and illumination lapse period is stored in the instrument, and updated in a non-volatile memory 29 every ten milliseconds.

The CPU and Currency Validator Interface

The currency/payment validator 40 can recognize different bills. Validation is set for the customary are the $1, $5, $10 and $20 bills. The currency/payment validator 40, however, may be set for any currency including foreign currency in diverse face values. The operator or religious institutions are able to dedicate any time interval to any bill value and store them in the memory of the CPU through push-buttons and LEDs displays (on the front panel of the unit). By pressing the “$” and up/down sets the dollar value (upper display), by pressing only the up/down, the time can be set (lower display), pressing “Enter” the desired (set) values will be stored. By pressing “Check” and the “$” button, the displays will show the currently existing settings. By pressing “Check” and the up/down button, the current time setting can be displayed. The moneys collected since the last reading (or collection) can be read by pressing “Enter” and “Check” buttons. The sum total amount that shows should have been collected and disposed in the money collection box at that time since the collection box was last emptied. To restart this type of counting (from collection to collection), press “Enter” and “Check” again. The total amount of the collected moneys can be read in a coded form only by pressing the “check” button. In this mode, the displays (upper/lower) will show a combination of numbers and letters. Inserting the numbers/letters will decode them to a real dollar value. This amount is the total collection from a pre-set time (factory set or password protected settings) and is achieved by a separate program.

It is understood that the above example and drawings are merely exemplary of the present invention and that changes in the method, system and apparatus and afore-discussed may be made without departing from the scope of the present invention as defined in the following claims.

Collection Accounting and Pilfer Control

It is an unfortunate fact of present reality that church collection boxes are pilfered. The electronic candle art desires a commercialization system with automated collection accounting and pilfer control.

In the present invention, there is provided a counter operably connected to the currency/payment validator 40 by electro-mechanical means well known in the art. When the collection box is opened, the counter records the date and time of the opening and the currency accumulated in the collection box since the last opening. This information is provided to the religious institution, the supplier and/or the manufacturer by electronic transmission means well known in the art. Non-wireless communication is also within the contemplation of the present invention. This collection box accounts information may also be encoded by the central processing units. A decryption means may be provided to the religious institution, supplier and/or manufacturer, whereby the electronically determined accounts and the physically accumulated monies are reconciled. In the event that any one collection does not correlate with the electronic accounts, the religious institution is able to identify the specific collector responsible for the deficient collection. The electronic accounts also permits a ready determination regarding distribution of the collected monies among the religious institutions, suppliers and manufacturer.

The automated system also contemplates providing an accounting for a pre-selected period of time, e.g. a month or a year, coins with the terms of commercialization between the manufacturer and the religious institution.

It is also within the contemplation of the present invention for the manufacturer to provide the services and activities of the supplier.

It is also within the contemplation of the present invention for the religious institution to purchase the electronic candles from the manufacturer and have the manufacturer service the electronic candles and the automated controls and accounting.

What is claimed is:

1. A system for the commercialization of electronic candle illuminations, comprising:
a plurality of electronic candles, each candle comprising means for illuminating the candle, and means for validating payment received from a user desirous of illuminating one candle, and means for operably connecting the payment validating means to the electronic candles, whereby with the validation of a payment for a predetermined time of illumination, at least one said candle is actuated for selected illumination by the user.

2. The system of claim 1, further comprising electronic candle illumination rate schedule means, whereby the user is apprised of the payment required to illuminate one candle for prescribed time periods.

3. The system of claim 2, further comprising:
a religious institution, wherein the electronic candles, payment validation means and illumination rate schedule means are available to the user at the religious institution;
a supplier or manufacturer, wherein the electronic candles and payment validation means are provided by the supplier or manufacturer to the religious institution, and further comprising means for authorizing the supplier to commercialize the electronic candles with the religious institution.

4. The system of claim 3, further comprising the religious institution providing the illumination rate schedule to the user prior to the payment.

5. The system of claim 1, further comprising means for collecting the payments and further comprising a control unit operably connected to the means for collecting payment said control means comprising means for providing an account statement of the accumulated payments for a pre-determined time.

6. The system of claim 5, wherein the account statement is encrypted and further comprising means for decrypting the encrypted account statement.

7. The system of claim 5, said pre-determined time comprising the time between a sequential collection of the payments.

8. The system of claim 3, said means for authorizing the supplier comprises a supplier and manufacturer agreement, whereby the supplier collecting accumulated payments for transfer to the religious institution and the manufacturer.

9. The system of claim 1, wherein the means for validating payment comprises a currency validator, whereby the user inserts currency into the currency validator and the electronic candles are actuated.

10. The system of claim 9, further comprising means for electronically connecting the currency validator to the candles.

11. An electronic candle comprising means for illuminating the candle, and means for actuating the candle for illumination upon receiving an electronic signal commensurate with the payment for illumination of the candle for a predetermined time.

12. The electronic candle of claim 11, further comprising means for encrypting, whereby an encrypted report is provided to a supplier or manufacturer of the electronic candle.

13. The electronic candle of claim 11, said means for illuminating the candle comprises means for a user touching the candle after said actuation.

14. A system for the commercialization of electronic candle illuminations, comprising:
a plurality of electronic candles, each candle comprising means for illuminating the candle, and means for validating payment received from a user desirous of illuminating one candle, and means for operably connecting the payment validating means to the electronic candles, whereby with the validation of a payment for a predetermined time of illumination, at least one said candle is actuated for selected illumination by the user further comprising;
a religious institution, wherein the electronic candles, payment validation means and illumination rate schedule means are available to the user at the religious institution;
a supplier or manufacturer, wherein the electronic candles and payment validation means are provided by the supplier or manufacturer to the religious institution, and further comprising means for authorizing the supplier to commercialize the electronic candles with the religious institution;
further comprising means for collecting the payments and further comprising a control unit operably connected to the means for collecting payment said control means comprising means for providing an account statement of the accumulated payments for a pre-determined time.

15. The system of claim 14, wherein the means for collecting payments comprises a collection box disposed at the religious institutions.
